(19) United States
(12) Patent Application Publication
(10) Pub. No.: US 2026/0331076 A1
(43) Pub. Date: Oct. 22, 2026

(54) DYNAMIC ADJUSTMENT OF DISPLAY PANEL SETTINGS

(71) Applicant: Hewlett-Packard Development Company, L.P., Spring, TX (US)

(72) Inventors: Shu-Ting Hsu, Taipei (TW); Po Cheng Liao, Taipei (TW); Yuan Hsi Cheng, Taipei (TW)

(73) Assignee: Hewlett-Packard Development Company, L.P., Spring, TX (US)

(21) Appl. No.: 19/484,328

(22) PCT Filed: May 23, 2023
(86) PCT No.: PCT/US2023/023249

§ 371 Date: Nov. 13, 2025

(51) Int. Cl. G09G 5/10; G06F 1/18

(52) U.S. Cl. CPC G09G 5/10; G06F 1/189; G09G 2320/0626; G09G 2320/08

(57) ABSTRACT

A display apparatus includes display controller circuitry in communication with power sensing circuitry. The power sensing circuitry measures an electrical characteristic indicative of power consumed by the display panel when the display panel displays content during a time period. The display controller circuitry obtains, as a set of power values based on measurements by the power sensing circuitry, the power consumed by the display panel at points of time during the time period. The display controller circuitry also determines a power parameter based on the set of power values, and controls the display panel to change to a different display mode when the display controller circuitry determines that the power parameter reaches a threshold.

### BACKGROUND

A display panel can be used to present video content on various devices. Some display panels may be integrated into a computing device, for example, laptops, tablets, all-in-one desktop computers, and any electronic device having a display screen. Other display panels may be separately housed and connected to a computing device that generates and transmits video content to the display panel for display. The display panel may also be configured to have different display modes.

### BRIEF DESCRIPTION OF THE DRAWINGS

The accompanying drawings, which are incorporated in and form a part of this specification, illustrate examples of the disclosure and, together with the description, explain principles of the examples.

FIG. 1 illustrates a system level block diagram for an example of a display apparatus.

FIGS. 2A, 2B and 2C illustrate various configurations of the display apparatus of FIG. 1.

FIGS. 3A, 3B, 3C, and 3D illustrate various configurations of the display panel.

FIGS. 4A, 4B, and 4C illustrate various block diagrams for examples of a display panel and power sensing circuitry.

FIG. 5 is a Table that lists parameters for the display of video content.

FIGS. 6A and 6B illustrate dynamic changes in an amount of power consumed by a display panel.

FIGS. 7A and 7B are flow diagrams that depict an operation of display controller circuitry according to some examples.

Like elements in the various figures are denoted by like reference numerals for consistency.

### DETAILED DESCRIPTION

Embodiments of the disclosure are described in detail below with reference to the accompanying figures. Unless otherwise indicated, like parts and method steps are referred to with like reference numerals.

Throughout the application, use of ordinal numbers (e.g., first, second, third, etc.) is not intended to imply or create any particular ordering for any of the elements. Nor does the use of ordinal numbers limit any element to being only a single element, unless expressly disclosed.

A display panel can be used to present video content on various devices. Some display panels may be integrated into a computing device, for example, laptops, tablets, all-in-one desktop computers, and any electronic device having a display screen. Other display panels may be separately housed and connected to a computing device that generates and transmits video content to the display panel for display. The display panel may also be configured to have different display modes.

The display panel may include preset display modes particularly configured for different uses or types of video content. Each display mode may include a collection of display parameters, such as, for example, brightness, contrast, color temperature, and sharpness, each with particular settings or values appropriate or desired for the use or type of video content. In some display panels, a user may adjust the display mode manually by using a pushbutton selector associated with the display panel or by navigating and manipulating display parameters or modes on a graphical user interface. However, users may not be aware that the display modes or parameters can be adjusted or may find the adjustment process to be tedious, complicated, or confusing. Accordingly, at a given point in time, the display panel displaying video content may not be configured in the appropriate display mode or with the appropriate display parameters appropriate or desired for the current use or type of video content on the display panel.

Accordingly, in some examples, systems, apparatuses, methods, and computer readable media storing instructions for execution are provided herein for a display controller circuitry to control a display mode based on power consumption by the display panel while video content is being displayed.

In one example, a display apparatus is provided that includes display controller circuitry in communication with power sensing circuitry. The power sensing circuitry measures an electrical characteristic indicative of power consumed by the display panel when the display panel displays content during a time period. The display controller circuitry obtains, as a set of power values based on measurements by the power sensing circuitry, the power consumed by the display panel at points of time during the time period.

For the power values that are present in the set of power values during the time period, a power parameter is a variable that conveys an amount of fluctuation or variation in the power values. The display controller circuitry may also determine the power parameter based on the set of power values, and controls the display panel to change to a different display mode when the display controller circuitry determines that the power parameter reaches a threshold.

In another example, a method for adjusting a display panel is provided. The method includes measuring, by power sensing circuitry when a display panel displays content during a time period, an electrical characteristic indicative of power consumed by the display panel; and obtaining, by display controller circuitry, as a set of power values based on measurements by the power sensing circuitry, the power consumed by the display panel at points of time during the time period; determining, by the display controller circuitry, a power parameter of the set of power values; and controlling, by the display controller circuitry when the display controller circuitry determines that the power parameter reaches a threshold, the display panel to change to a different display mode having a different setting for at least one display parameter of the display.

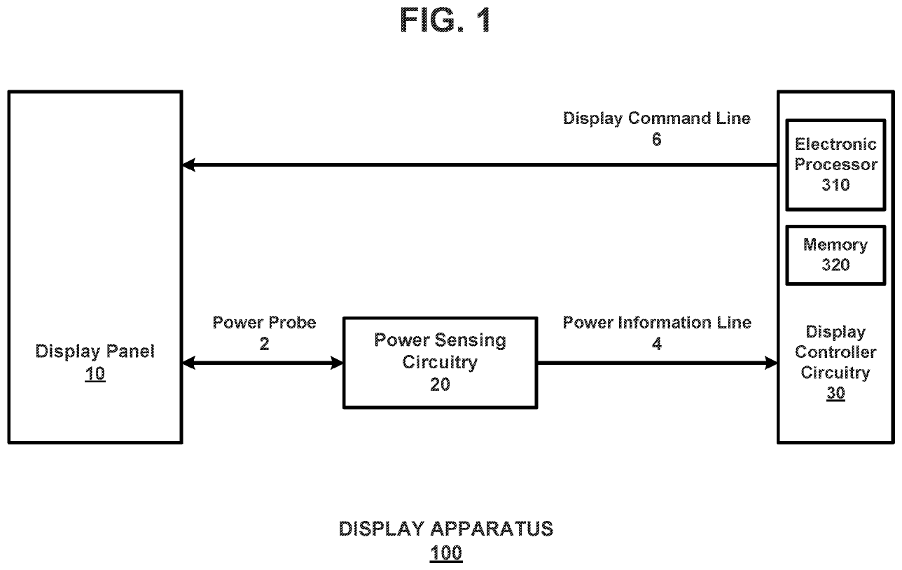

Referring to FIG. 1, an example display apparatus 100 is provided. Shown in FIG. 1, the display apparatus 100 comprises the display panel 10, the power sensing circuitry 20, and the display controller circuitry 30. Also shown in FIG. 1 are power probe 2, power information line 4, and display command line 6. In some examples, the display apparatus 100 may include additional components.

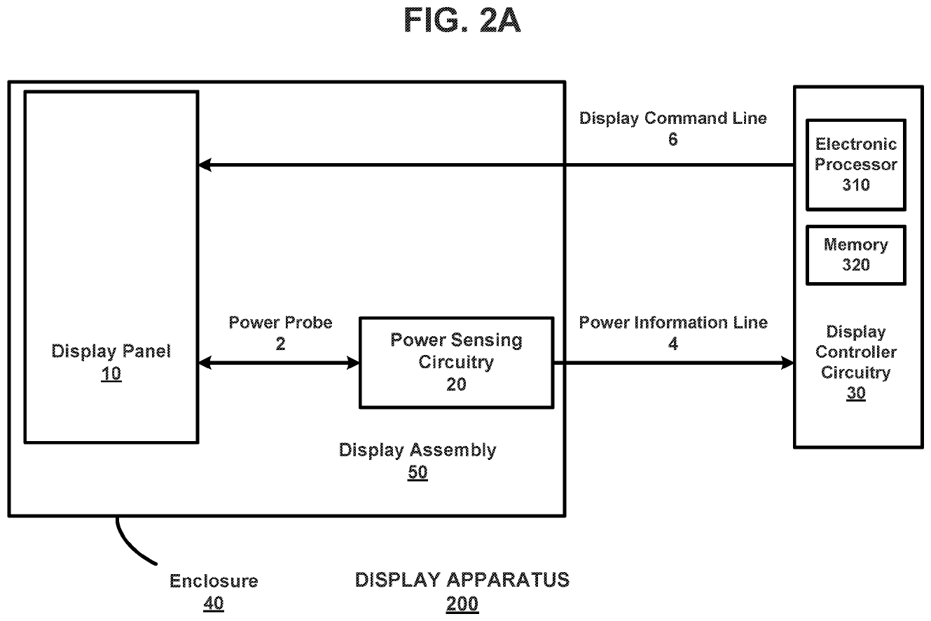

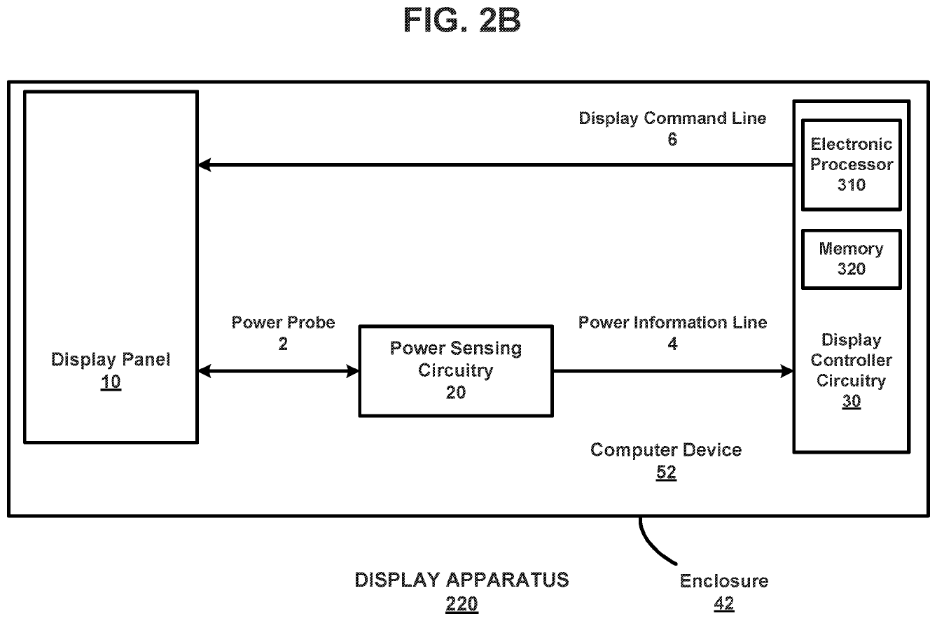

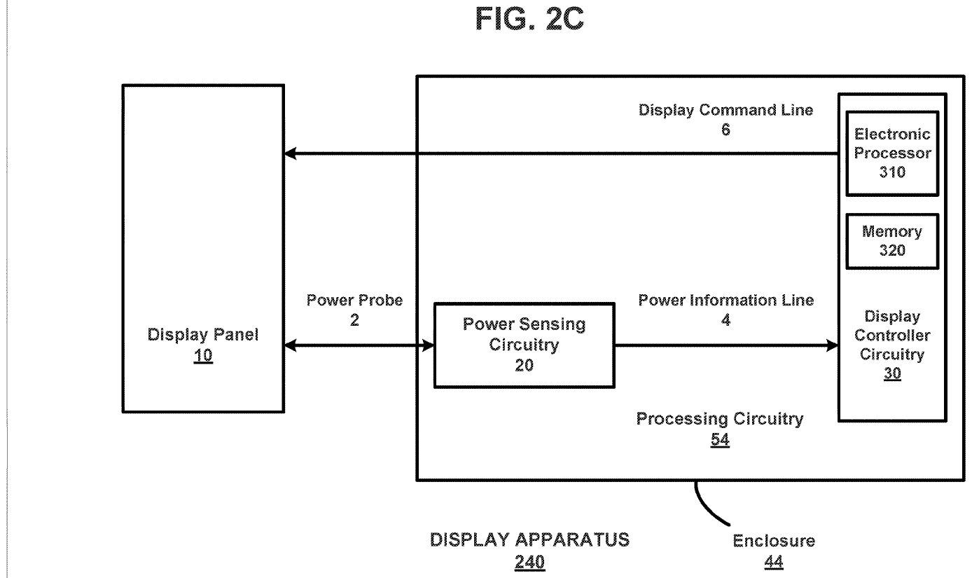

FIGS. 2A, 2B, and 2C illustrate different configurations of the display apparatus 100, identified as display apparatuses 200, 220, and 240, respectively. Except for the differences noted herein, the description of the display apparatus 100 is similarly applicable to the display apparatuses 200, 220, and 240.

Depicted in FIG. 2A is display apparatus 200, which comprises the display panel 10 and the power sensing circuitry 20 being housed together in enclosure 40 of display assembly 50. The display controller circuitry 30 in display apparatus 200 is sited separate and apart from the display assembly 50 in FIG. 2A. An example of the display apparatus 200 is any electronic device having a display assembly 50 housed separate and apart from the display controller circuitry 30.

Depicted in FIG. 2B is display apparatus 220, which comprises the display panel 10, the power sensing circuitry 20 and the display controller circuitry 30 being housed together in enclosure 42 of a computer device 52. An example of the display apparatus 220 is a laptop, a smartphone, a tablet, an all-in-one desktop computer, or any electronic device having the display panel 10 and the power sensing circuitry 20 enclosed together with the display controller circuitry 30.

Depicted in FIG. 2C is display apparatus 240, which comprises the power sensing circuitry 20 and the display controller circuitry 30 being housed together in enclosure 44 of processing circuitry 54. The display panel 10 in FIG. 2C is sited separate and apart from processing circuitry 54. An example of the display apparatus 240 is any electronic device having the display panel 10 housed separate and apart from the processing circuitry 54.

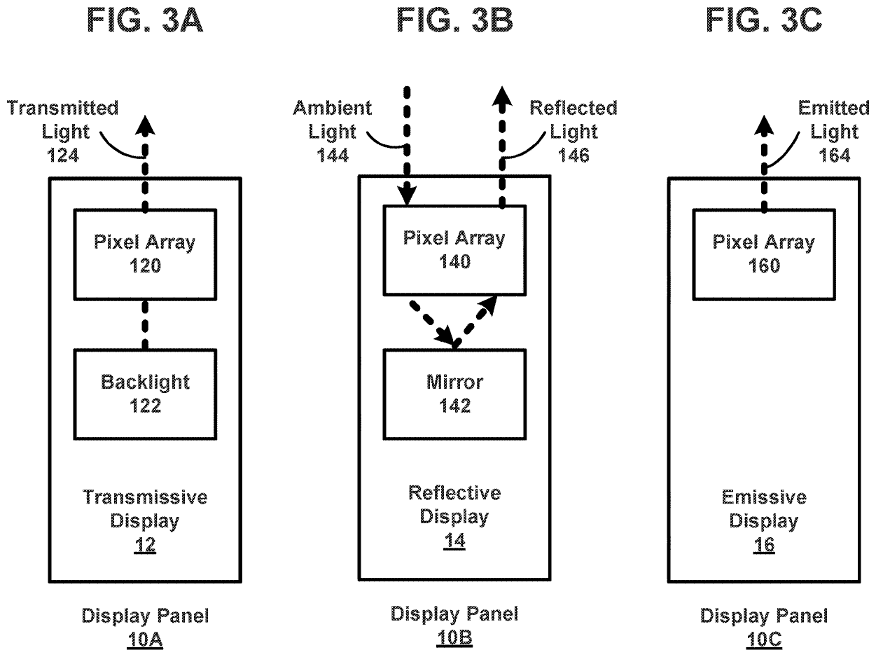

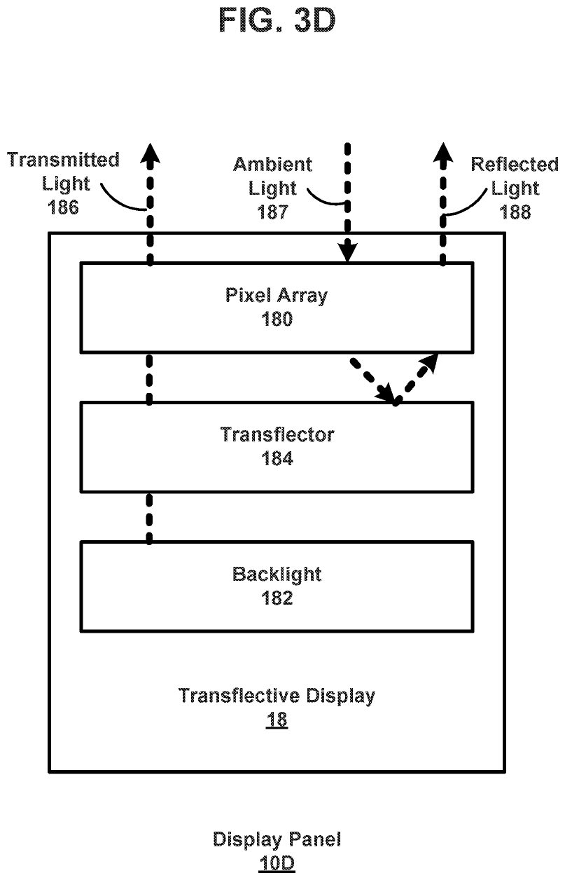

With reference to FIGS. 3A, 3B, 3C, and 3D, the display panel 10 is an electronic display device. In some examples, the electronic display device is a touchscreen display.

FIG. 3A presents the display panel 10 as the display panel 10A that is comprised of a pixel array 120 and a backlight 122. The pixel array 120 is a matrix of individual pixels that, when operating, presents video content for viewing. When the pixel array 120 presents the video content for viewing, the display panel 10A displays the video content. The video content may be a single image or a stream of video. The stream of video comprises a sequence of images (e.g., a continuous sequency of images that are displayed in succession). The video content is viewable when the display panel 10A displays the video content. The pixel array 120 may be a liquid crystal display. The pixel array 120 may be a light-emitting diode (LED) display. The light-emitting diode display may be an organic light-emitting diode (OLED) display.

The backlight 122 is a light source that emits light through the pixel array 120 while the pixel array 120 presents the video content for viewing. The light through the pixel array 120, when emitted from the backlight 122, is emitted from the display panel 10A in the form of transmitted light 124. For example, the backlight 122 may generate light, and the pixel array 120 may be controlled to manipulate the light emitted by the backlight 122 to present the video content by way of the transmitted light 124. Each pixel in the pixel array 120 may include subpixels (e.g., a red, blue, and green subpixel) that may be controlled in combination to change the color of light received from the backlight 122 and ultimately emitted by the display panel 10A. In some examples, the display panel 10A is a backlit transmissive display 12.

FIG. 3B presents the display panel 10 as the display panel 10B that is comprised of a pixel array 140 and a mirror 142. The pixel array 140 is a matrix of individual pixels that, when operating, presents video content for viewing. When the pixel array 140 presents the video content for viewing, the display panel 10B displays the video content. The video content may be a single image or a stream of video. The stream of video comprises a sequence of images (e.g., a continuous sequency of images that are displayed in succession). The video content is viewable when the display panel 10B displays the video content. The pixel array 140 may be a liquid crystal display. The pixel array 140 may be a light-emitting diode (LED) display. The light-emitting diode display may be an organic light-emitting diode (OLED) display.

The pixel array 140 may pass, through the pixel array 140, ambient light 144 that is incident on a surface of the pixel array 140. While the pixel array 140 presents the video content for viewing, the mirror 142 reflects the ambient light 144 that strikes a surface of the mirror 142 when the ambient light 144 passes through the pixel array 140. The light through the pixel array 140, when reflected from the mirror 142, is emitted from the display panel 10B in the form of reflected light 146. Each pixel in the pixel array 140 may include subpixels (e.g., a red, blue, and green subpixel) that may be controlled in combination to change the color of light received from the mirror 142 and ultimately emitted by the display panel 10B. In some examples, the display panel 10B is a reflective display 14.

FIG. 3C presents the display panel 10 as the display panel 10C that is comprised of a pixel array 160. The pixel array 160 is a matrix of individual pixels that, when operating, presents video content for viewing. When the pixel array 160 presents the video content for viewing, the display panel 10C displays the video content. The video content may be a single image or a stream of video. The stream of video comprises a sequence of images (e.g., a continuous sequency of images that are displayed in succession). The video content is viewable when the display panel 10C displays the video content. The pixel array 160 may be a liquid crystal display. The pixel array 160 may be a light-emitting diode (LED) display. The light-emitting diode display may be an organic light-emitting diode (OLED) display. The pixel array 160 presents the video content for viewing. The light emitted from the pixel array 160 is emitted from the display panel 10C in the form of emitted light 164. Each pixel in the pixel array 160 may include subpixels (e.g., a red, blue, and green subpixel) that may be controlled in combination to change the color of light emitted by the display panel 10C. In some examples, the display panel 10C is an emissive display 16.

FIG. 3D presents the display panel 10 as the display panel 10D that is comprised of a pixel array 180, a backlight 182 and a transflector 184. The pixel array 180 is a matrix of individual pixels that, when operating, presents video content for viewing. When the pixel array 180 presents the video content for viewing, the display panel 10D displays the video content. The video content may be a single image or a stream of video. The stream of video comprises a sequence of images (e.g., a continuous sequency of images that are displayed in succession). The video content is viewable when the display panel 10D displays the video content. The pixel array 180 may be a liquid crystal display. The pixel array 180 may be a light-emitting diode (LED) display. The light-emitting diode display may be an organic light-emitting diode (OLED) display.

The pixel array 180 may pass, through the pixel array 180, ambient light 187 that is incident on a surface of the pixel array 180. While the pixel array 180 presents the video content for viewing, the transflector 184 reflects the ambient light 187 that strikes a surface of the transflector 184 when the ambient light 187 passes through the pixel array 180. The light through the pixel array 180, when reflected from the transflector 184, is emitted from the display panel 10D in the form of reflected light 188.

The backlight 182 is a light source that emits light through the transflector 184 and the pixel array 180 while the pixel array 180 presents the video content for viewing. The light through the transflector 184 and the pixel array 180, when emitted from the backlight 182, is emitted from the display panel 10D in the form of transmitted light 186. For example, the backlight 182 may generate light, and the pixel array 180 may be controlled to manipulate the light emitted by the backlight 182 to present the video content by way of the transmitted light 186. Each pixel in the pixel array 180 may include subpixels (e.g., a red, blue, and green subpixel) that may be controlled in combination to change the color of light received from the backlight 182 and ultimately emitted by the display panel 10D.

The transflector 184 may be a half-mirror. As the half-mirror, the transflector 184 may reflect the ambient light 187 that is incident on one surface of the transflector 184. Also as the half-mirror, the transflector 184 may transmit light emitted from the backlight 182 through the transflector 184 when the light emitted from the backlight 182 is incident on another surface of the transflector 184. In some examples, the display panel 10D is a transflective display 18.

The display panel 10 may display the video content at various display modes when the display panel 10 displays the video content. A display mode influences the manner in which the display panel 10 displays the video content. Accordingly, the display mode can impact a visual perception by a viewer viewing the video content as to how the video content appears to the viewer of the video content.

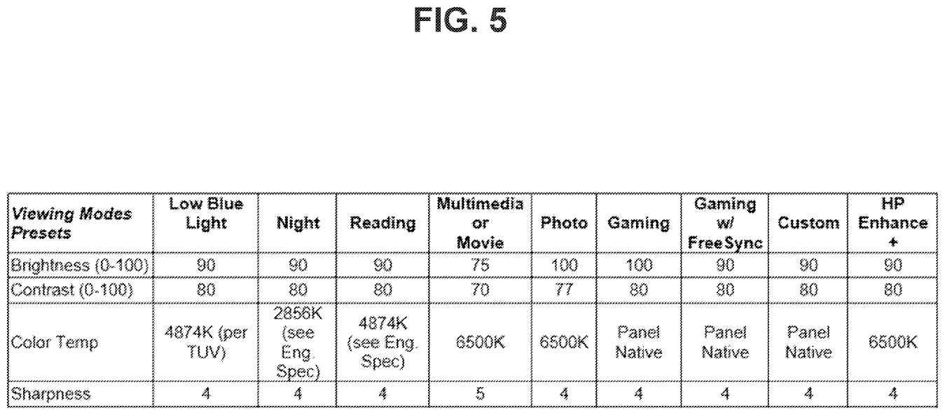

The display panel 10 may have a plurality of display modes, including preset display modes and custom display modes. Each display mode may be particularly configured for different uses or types of video content. For example, each display mode may include a collection of display parameters, such as, for example, brightness, contrast, color temperature, and sharpness, each with particular values appropriate or desired for the use or type of video content. Display modes can include, for example, low blue light mode, night mode, reading mode, multimedia or movie mode, photo mode, gaming mode, gaming with free synchronization mode, custom mode, among other modes. FIG. 5 is a Table that lists values or settings for parameters of the display modes. These parameters include brightness, contrast, color temperature, and sharpness.

The brightness parameter can indicate a relative amount or intensity of light emitted by the display panel 10. The brightness parameter may be indicated numerically on a scale between a lowest brightness level and a highest brightness level. For example, in the Table of FIG. 5, the brightness parameter may be a value between 1 and 100, with 1 representing the lowest brightness level, and 100 representing the highest brightness level. The display panel 10, when operating with the brightness parameter at a higher number, presents the video content in a manner that is brighter (e.g., with a higher intensity) than when the display panel 10 operates with a brightness parameter at a lower number. A brightness of the display panel 10 when the display panel 10 is set to a (first) display mode can differ from a brightness of the display panel 10 when the display panel 10 is set to another (second) display mode. For example, the display panel 10 may display the video content at a (first) brightness when the display panel 10 is set at one of the display modes and may display the video content at a (second) different brightness when the display panel 10 is set at another of the display modes.

The contrast parameter can indicate an amount of relative difference in luminance between dark and bright areas of the video content on the display panel 10. The contrast parameter may be indicated numerically on a scale between a lowest contrast level and a highest contrast level. For example, in the Table of FIG. 5, the contrast parameter may be a value between 1 and 100, with 1 representing the lowest contrast level, and 100 representing the contrast level. The display panel 10, when operating with the contrast parameter at a higher number, presents the video content in a manner that has a larger difference in luminance between dark and bright areas of the video content than when the display panel 10 operates with a contrast parameter at a lower number. A color contrast of the display panel 10 when the display panel 10 is set to the (first) display mode can differ from a color contrast of the display panel 10 when the display panel 10 is set to another (second) display mode. For example, the display panel 10 may display the video content at a (first) color contrast when the display panel 10 is set at one of the display modes and may display the video content at a (second) different color contrast when the display panel 10 is set at another of the display modes.

The color temperature parameter can indicate the color of the light emitted by the display. The color temperature parameter may be indicated using a numerical value on a scale between a lowest color temperature level and a highest temperature level of the display panel 10, and may refer to the Kelvin scale. For example, in the Table of FIG. 5, the color temperature parameter may be a value between 2500K (or another Kelvin value) and 6500K (or another Kelvin value), with 2500K representing the lowest color temperature level, and 6500K representing the highest color temperature level. The display panel 10, when operating with the color parameter at a higher number, presents the video content in a manner that may be viewed as being cooler or more blue-like than when the display panel 10 operates with a contrast parameter at a lower number, which may be viewed as being warmer or more yellow-like. The color temperature of the display panel 10 when the display panel 10 is set to the (first) display mode may differ from a color temperature of the display panel 10 when the display panel 10 is set to another (second) display mode. For example, the display panel 10 may display the video content at a (first) color temperature when the display panel 10 is set at one of the display modes and may display the video content at a (second) different color temperature when the display panel 10 is set at another of the display modes.

The sharpness parameter can indicate an amount of clarity or edge contrast with which the video content is displayed on the display panel 10. The sharpness parameter may be indicated numerically on a scale between a lowest sharpness level and a highest sharpness level. For example, in the Table of FIG. 5, the contrast parameter may be a value between 1 and 10, with 1 representing the lowest sharpness level, and 10 representing the sharpness level. The display panel 10, when operating with the sharpness parameter at a higher number, presents the video content in a manner that appears clearer with higher edge contrast between displayed objects (e.g., more distinct contours) than when the display panel 10 operates with a sharpness parameter at a lower number.

To control these parameters, the display controller circuitry 30 (e.g., the display controller circuitry 30 illustrated in FIGS. 1-2C) may provide control signals to the display panel 10. For example, to increase brightness, the display controller circuitry 30 may control the display panel 10 to increase intensity. Similarly, to adjust color temperature, the display controller circuitry 30 may control the pixel array 120 to adjust the color emitted by the pixel array 120 or may control the pixel array 120 by adjusting a color multiplier applied to control signals provided to the pixel array 120. As an additional example, the display controller circuitry 30 may control the pixel array 120 to adjust contrast by adjusting a contrast ratio multiplier applied to control signals provided to the pixel array 120, to adjust sharpness by adjusting pixels at boundaries of displayed objects to have smoother or more abrupt transitions therebetween. In some examples, the display controller circuitry 30 may control these display parameters using other techniques. Additionally, in some examples, other ranges and scales than shown in FIG. 5 and noted above are used to indicate the display parameters for the display panel 10 and display modes.

The display panel 10 consumes power when presenting the video content. The power consumed by the display panel 10 may be the amount of electrical energy consumed by the display panel 10.

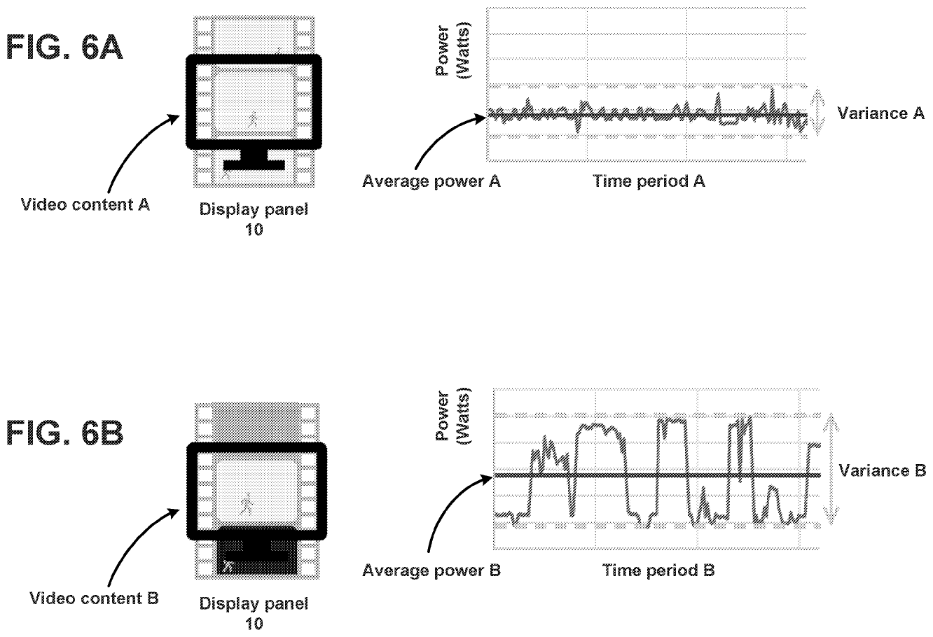

FIGS. 6A and 6B illustrate that the amount of power consumed by the display panel 10 can change dynamically in response to changes in the video content on the display panel 10.

For example, FIG. 6A depicts a scenario that occurs during time period A when the display panel 10 consumes power while displaying the video content A. Shown in FIG. 6A is average power A, which is an average amount of power consumed by the display panel 10 during time period A. Variance A in FIG. 6A depicts a fluctuation or variance in the power consumed by the display panel 10 during time period A.

In FIG. 6B, average power B is an average amount of power consumed by the display panel 10 during time period B. Variance B in FIG. 6B depicts a fluctuation or variance of the power consumed by the display panel 10 during time period B. FIG. 6B depicts a scenario that occurs during time period B when the display panel 10 consumes power while displaying the video content B.

As illustrated, the variance A is less than the variance B. The amount of variation in the power consumed by the display panel 10 may correlate to the amount of change in the video content being displayed by the display panel 10. For example, video content A in FIG. 6A may vary more than video content B in FIG. 6B. The amount of change in the video content being displayed may correlate to the type of video content being displayed.

Video content including a movie or multimedia may include continuously changing display frames from a stream of changing images, resulting in larger variance on power consumption. In contrast, a digital book or still image may have less change in video content over time, resulting in lower variance in power consumption.

In some examples, time period B commences at the conclusion of time period A. Alternatively, time period A may commence at the conclusion of time period B. Each of the time periods is a duration of time. In some examples, the duration of time may be a length of time for the display panel 10 to display a field of the video content. In some examples, the duration of time is a length of time for the display panel 10 to display a frame of the video content.

Referring to FIG. 1 and FIGS. 2A-2C, the power probe 2 is an electrical connection between the display panel 10 and the power sensing circuitry 20. In some examples, the electrical connection for the power probe 2 is wiring between the display panel 10 and the power sensing circuitry 20. For example, the wiring between the display panel 10 and the power sensing circuitry 20 may be a single wire or may be multiple wires. In some examples, the power probe 2 electrically connects the display panel 10 directly to the power sensing circuitry 20.

The power sensing circuitry 20 is an electronic device that monitors the power consumed by the display panel 10. The power sensing circuitry 20 may include a circuit that implements a power meter. To monitor the power consumed by the display panel 10, the power sensing circuitry 20 measures an electrical characteristic. The power sensing circuitry 20 measures the electrical characteristic when the display panel 10 presents the video content. The electrical characteristic may be, for example, electrical current, voltage, or power. For example, the power sensing circuit 20 may include a current sensor positioned to sense current flow to (or drawn by) the display panel 10. As another example, the power sensing circuit 20 may include a voltage sensor positioned to measure voltage of a component or components of the display panel 10 that is indicative of power consumed by the display panel 10. In another example, the power sensing circuitry 20 may include a sensor that senses the wattage consumed by the display panel 10. For example, the (power) sensor may include a current sensor and a voltage sensor to sense current and voltage, respectively, from which the power sensing circuitry 20 may obtain the wattage.

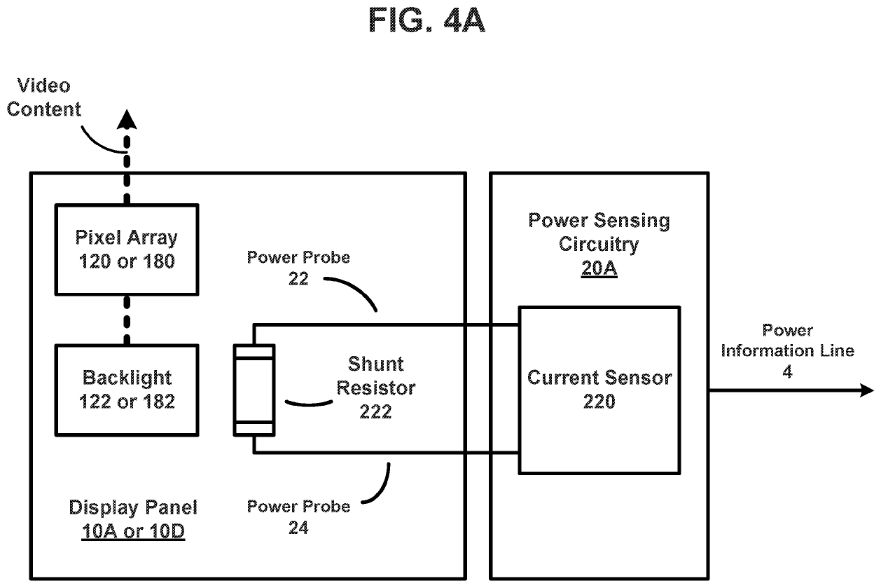

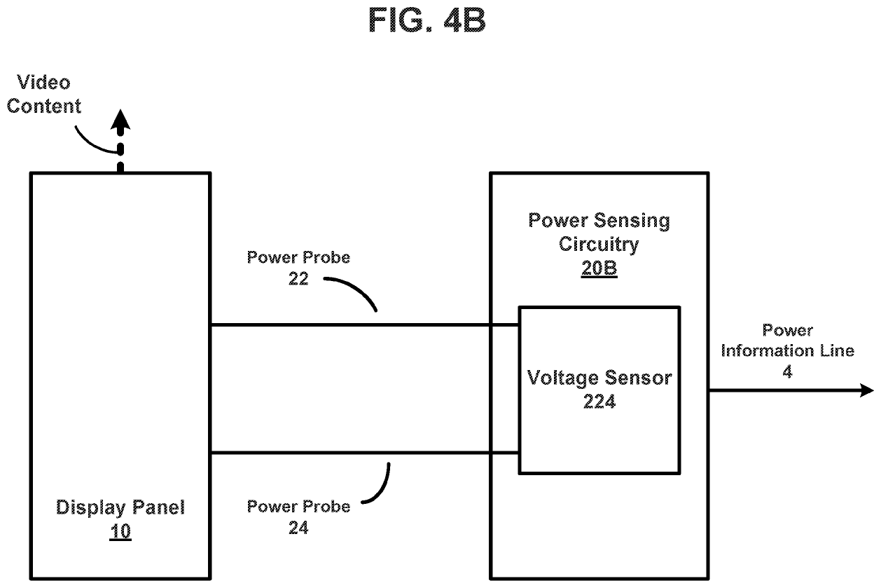

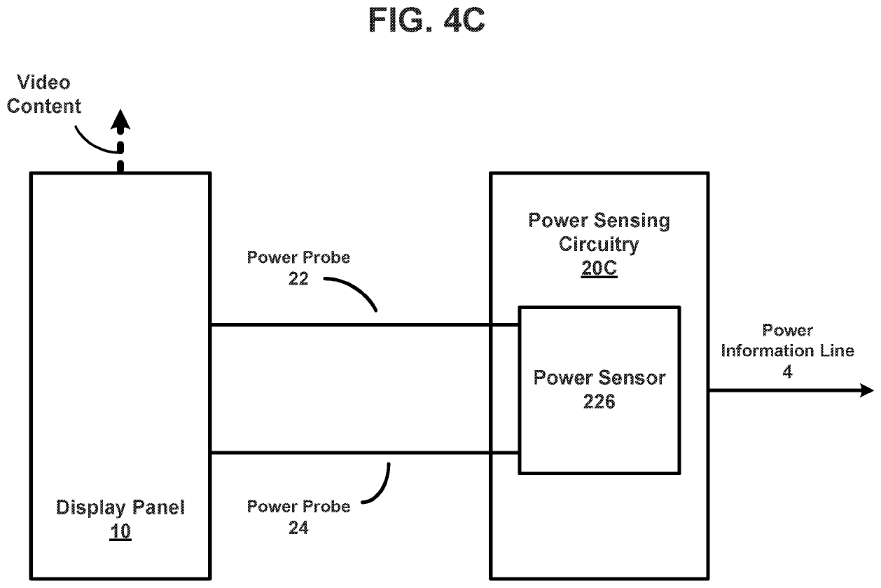

FIG. 4A illustrates an example of the display panel 10A or 10D combined with the power sensing circuitry 20A. The details of the display panel 10A are illustrated in FIG. 3A and the details of the display panel 10D are illustrated in FIG. 3D. The transflector 184, while being present in the display panel 10D is omitted from FIG. 4A for simplicity.

The power sensing circuitry 20A is an example of the power sensing circuitry 20 of FIGS. 1, 2A, 2B, and/or 2C. The power sensing circuitry 20 is illustrated in FIG. 4A as the power sensing circuitry 20A that includes a current sensor 220 and a shunt resistor 222. The display panel 10A or 10D may include the shunt resistor 222. The current sensor 220 is coupled across the shunt resistor 222. The shunt resistor 222 may be coupled in series with a power supply to the backlight 122 of the display panel 10A. Alternatively, the shunt resistor 222 may be coupled in parallel with the power supply to the backlight 122 of the display panel 10A. By sensing the voltage across the shunt resistor 222, which has a known resistance, the current sensor 220 can infer and output a signal indicative of the current being drawn by the backlight 122 (e.g., using the equation I=V/R).

In FIGS. 4A, 4B, and 4C, the power probe 2 includes a power probe 22 and a power probe 24. The signal output by the current sensor 220 may be an analog signal or a digital signal.

As noted, the power sensing circuitry 20A in FIG. 4A is an example of the power sensing circuitry 20. In some examples, the power sensing circuitry 20 may take other forms and be coupled to the display panel 10 in ways other than illustrated in FIG. 4A. For example, a voltage sensor 224 is in FIG. 4B and a power sensor 226 is in FIG. 4C.

The power probe 2 may be coupled to the display panel 10 such that the power sensing circuitry 20 may, for example, indicate a current, voltage, or wattage on the power probe 2, which is indicative of the current, voltage, or wattage consumed or applied to the display panel 10. The electrical characteristic is indicative of the power consumed by the display panel 10. By monitoring the power consumed by the display panel 10, the power sensing circuitry 20 ascertains an amount of the power consumed by the display panel 10.

The power sensing circuitry 20 obtains samples of the electrical characteristic when the power sensing circuitry 20 measures the electrical characteristic at various points of time. For example, one of the samples is a value of the electrical characteristic at a point in time and another of the samples is a value of the electrical characteristic at another point in time. The power sensing circuitry 20 converts the measurements of the electrical characteristic into the samples. The power sensing circuitry 20 derives each sample from an independent measurement of the electrical characteristic. The power sensing circuitry 20 generates several of the samples during each of the time periods.

The power sensing circuitry 20 outputs power consumption information onto a power information line 4. The power consumption information may include a set of power values. The set of power values is a collection of the samples generated by the power sensing circuitry 20 during any one of the time periods. The power consumption information may include packets of digital data and/or may include an analog signal.

The power sensing circuitry 20 outputs the power consumption information to the display controller circuitry 30 via the power information line 4. The power information line 4 electrically connects the power sensing circuitry 20 with the display controller circuitry 30. The power information line 4 may be an electrical link (e.g., wiring or wirelessly) between the power sensing circuitry 20 and the display controller circuitry 30.

The power sensing circuitry 20 may output the power consumption information onto the power information line 4 at regular time intervals. The power sensing circuitry 20 may output the power consumption information onto the power information line 4 intermittently, continuously, and/or as a data stream. The power sensing circuitry 20 may output the power consumption information as a digital signal or as an analog signal. Additionally, when the power sensing circuitry 20 outputs the power consumption information onto the power information line 4, the power sensing circuitry 20 may electronically communicate directly with the display controller circuitry 30.

The display controller circuitry 30 includes an electronic processor 310 and a memory 320. The electronic processor 310 is configured to communicate with the memory 320 to store data and retrieve stored data. The electronic processor 310 is also configured to receive instructions and data from the memory 320 and execute, among other things, the instructions. In particular, the electronic processor 310 executes instructions stored in the memory 320. Thus, the display controller circuitry 30, via the electronic processor 310 and the memory 320, can be configured to perform or control the functions of the display controller circuitry 30 described herein, including analyzing power data for the display panel 10 and controlling the display panel 10 based on the analysis.

The memory 320 can include read-only memory (“ROM”), random access memory (“RAM”), other non-transitory computer-readable media, or a combination thereof. The memory 320 can include instructions for the electronic processor 310 to execute. The instructions can include software executable by the electronic processor 310 to enable the display controller circuitry 30 to, among other things, perform or control the functions of the display controller circuitry 30 described herein, including analyzing power data for the display panel 10 and controlling the display panel 10 based on the analysis. The software can include, for example, firmware, one or more applications, program data, filters, rules, one or more program modules, and other executable instructions.

The display controller circuitry 30 is an electronic device that receives the power consumption information from the power sensing circuitry 20. Specifically, the display controller circuitry 30 receives the power consumption information from the power information line 4. Additionally, when the display controller circuitry 30 receives the power consumption information from the power information line 4, the display controller circuitry 30 may electronically communicate directly with the power sensing circuitry 20.

In some examples, the display controller circuitry 30 receives the power values generated by the power sensing circuitry 20 individually over time (e.g., one-by-one as the power values are generated) and stores the power values or otherwise associates the power values as the set of power values. The set of power values may be associated with a particular time period over which measurements of the electrical characteristic were obtained and/or the power values were generated. In other examples, the power values for the set of power values are amassed at the power sensing circuitry 20 and transmitted together (e.g., in one communication or in batches with multiple power values) as the power consumption information.

Whether the power consumption information is sent in one or more multiple communications, the display controller circuitry 30 may extract the set of power values from the power consumption information when the display controller circuitry 30 receives the power consumption information from the power information line 4. The display controller circuitry 30 may store the power consumption information or the set of power values in the memory 320 of the display controller circuitry 30.

When the display controller circuitry 30 extracts the set of power values from the power consumption information, the display controller circuitry 30 processes the set of power values to perform an analysis of the set of power values. By performing the analysis of the set of power values, the display controller circuitry 30 may ascertain the amount of power consumed by the display panel 10 during the time period. In some examples, the amount of power consumed by the display panel 10 may be the average amount of power consumed by the display panel 10 during the time period. In some examples, the amount of power consumed by the display panel 10 is the fluctuation in the power consumed by the display panel 10 during the time. Specifically, the amount of power consumed by the display panel 10 may be the variance (e.g., the standard deviation) in the power consumed by the display panel 10 during the time period.

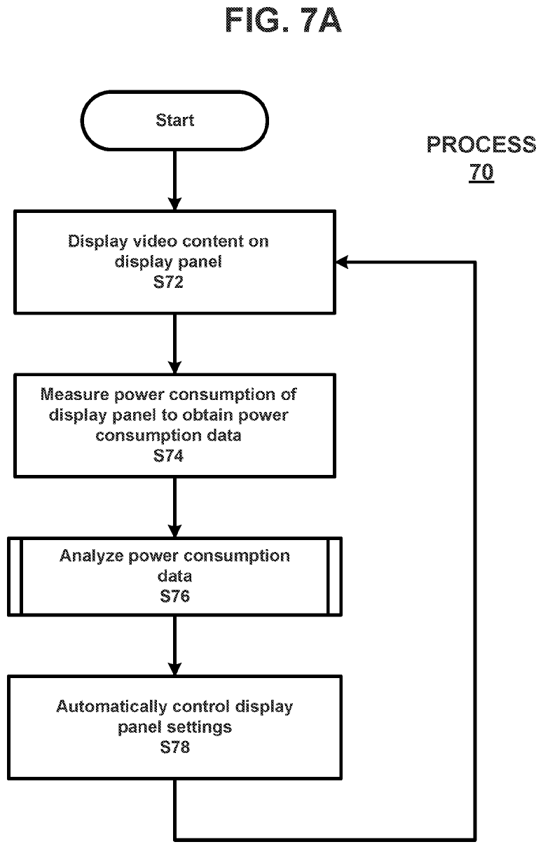

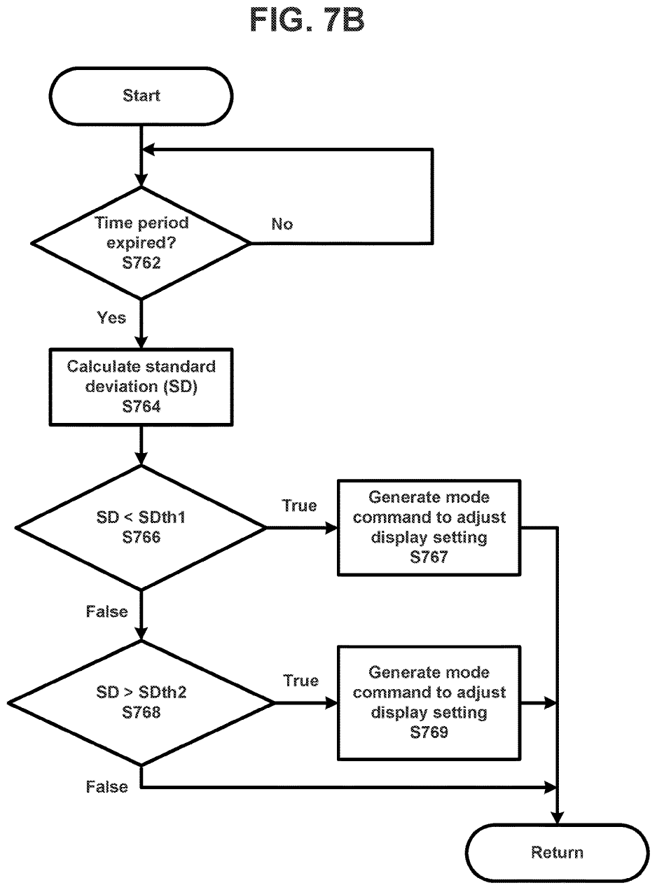

In the display controller circuitry 30, the memory 320 stores predetermined display mode data. The predetermined display mode data comprises predetermined information that correlates a display mode with an amount of power. The predetermined information may include one or more power parameter thresholds, such as described in further detail with respect to process 70 of FIG. 7A. The display controller circuitry 30 may obtain the predetermined display mode data from memory 320 to perform the analysis of the set of power values. Additionally, the display controller circuitry 30 may perform the analysis and, in response, generate a mode command, for example, when the display controller circuitry 30 obtains the predetermined display mode data and the set of power values. The display control circuitry 30 may determine the particular mode command to output based on an analysis of the set of power values using the predetermined information (e.g., the power parameter thresholds).

An example of such analysis is described in further detail below with respect to the process 70. The one or more power parameter thresholds may include an upper threshold, a lower threshold, and additional thresholds. The thresholds may define ranges of the power parameter that are mapped, respectively, to corresponding display modes. For example, power parameters above the upper threshold may be mapped to a first display mode, power parameter values between the upper threshold and a lower threshold may be mapped to a second display mode, and power parameter values lower than the lower threshold may be mapped to a third display mode. In some examples, additional thresholds defining additional ranges (with corresponding display modes) are also included.

A mode command generated and output by the display controller circuitry 30 indicates a display mode for the display panel 10. The mode command may include an identifier of the display mode (e.g., low blue light mode, night mode, reading mode, movie mode, etc.), display values or settings of display parameters for the display mode (e.g., 90 for brightness, 80 for contrast, 4874K for color temperature, and 4 for sharpness), or more direct display configuration signals to control the display panel 10 to operate in the display mode (e.g., when the display controller circuitry 30 is integrated with the display panel 10).

The display command line 6 electrically connects the display controller circuitry 30 with the display panel 10. The display command line 6 may be an electrical link (e.g., wiring or wirelessly) between the display controller circuitry 30 and the display panel 10. The display controller circuitry 30 outputs, onto the display command line 6, display mode information comprising the mode command.

The display controller circuitry 30 may output the display mode information onto the display command line 6 at regular time intervals, intermittently, as a data stream, and/or as a continuous signal. The display controller circuitry 30 may output the display mode information onto the display command line 6 as a digital signal or as an analog signal. When the display controller circuitry 30 outputs the display mode information onto the display command line 6, the display controller circuitry 30 may electronically communicate directly with the display panel 10.

The display panel 10 receives the display mode information from the display controller circuitry 30. Specifically, the display panel 10 receives the display mode information from the display command line 6. When the display panel 10 receives the display mode information from the display controller circuitry 30, the display panel 10 extracts the mode command from the display mode information. When the display panel 10 extracts the mode command from the display mode information, the mode command controls the display panel 10 in a manner that causes the display panel 10 to the set the display parameters for the display mode of the display panel 10 to the display parameters that are indicated the mode command.

The display controller circuitry 30 may be implemented as any suitable processing circuitry including, but not limited to at least one of a microcontroller, a single processor, and a multiprocessor. The display controller circuitry 30 may include (e.g., as the electronic processor 310) at least one of a video scaler integrated circuit (IC), an embedded controller (EC), a central processing unit (CPU), a graphics processing unit (GPU), and an accelerated processing unit (APU).

In some examples, the display controller circuitry 30 may include a video scaler IC that controls the display mode of the display panel 10. When the display controller circuitry 30 includes the video scaler IC, the display controller circuitry 30 may also, via the video scaler IC, receive the video content from a connected computer device (e.g., in a separate housing from the display panel 10 connected by a video cable (e.g., HDMI, DVI, mini DisplayPort, DisplayPort, VGA, USB_C, Thunderbolt, etc.). The video scaler IC may further (i) upscale the video content by converting the resolution of the video content from a lower resolution to a higher resolution, and/or (ii) downscale the video content by converting the resolution of the video content from a higher resolution to a lower resolution. The video scaler IC may further control the display panel 10 to display the video content, as upscaled or downscaled. Additionally, the video scaler IC may obtain and analyze power consumption information and control the display panel 10 (e.g., as described below with respect to FIG. 7A).

In some examples, the display controller circuitry 30 (e.g., the electronic processor 310) includes an embedded controller (EC) and a further electronic processor. In some examples, the EC and additional processor are housed in the same enclosure (e.g., within a laptop, tablet, or all-in-one desktop computer). In such examples, the EC may receive and process signals from a keyboard, touchpad, power button, laptop lid switch, and the like.

Additionally, in some examples including the EC, the EC may obtain and analyze power consumption information and control the display panel 10 (e.g., as described below with respect to FIG. 7A). The additional processor may be, for example, a central processing unit (CPU), an accelerated processing unit (APU), a discrete graphics processing unit (dGPU), or the like that controls the display panel 10 to display the video content. The EC may generate controls for the additional processor (e.g., as described below with respect to FIG. 7A) to control the display panel 10.

In other examples including the EC, the EC may collect the power consumption information and provide the power consumption information to the additional processor. For example, the additional processor may execute an operating system (OS) for the laptop, table, or all-in-one desktop computer. The OS app may include software, executed by the additional processor, to obtain and analyze power consumption information and control the display panel 10 (e.g., as described below with respect to FIG. 7A), whereby the memory 320 stores the OS app.

Referring to FIG. 7A, a flowchart showing an example of process 70 for adjusting the display panel 10 is illustrated in accordance with some aspects of the disclosure. In FIG. 7A, the flow diagram depicts an operation of display apparatus 100, 200, 220, or 240, or a portion thereof. Process 70 can be executed by display apparatus 100, 200, 220, or 240, or a portion thereof. One or more algorithms for performing process 70 can be stored in instructions in memory 320, and executed by the electronic processor 310, for example. Although the blocks of process 70 are illustrated in a particular order, one or more of the blocks may be executed in another order or in parallel (partially or entirely) with another block or blocks of the process 70. Although the process 70 is described with respect to the display apparatuses 100, 200, 220, and/or 240, in some examples, the process 70 is executed by another device or within another system.

In the display controller circuitry 30, the memory 320 stores the predetermined threshold values and the predetermined display mode data. The predetermined display mode data comprises predetermined information that correlates of a display mode with an amount of power.

Process 70 in FIG. 7A commences when power is applied to the display panel 10. The display apparatuses 100, 200, 220, and/or 240 may perform the operation depicted by FIG. 7A as long as the power is applied to the display panel 10.

In block S72, the display panel 10 displays the video content during a time period.

In block S74, the power sensing circuitry 20 measures, when the display panel 10 displays the video content during the time period, an electrical characteristic indicative of power consumed by the display panel 10. For example, to measure the electrical characteristic indicative of power consumed by the display panel 10, the power sensing circuitry 20 may measure current, a voltage, or power consumed by the display panel 10. As described above, the power sensing circuitry 20 may sense the electrical characteristic of the display panel 10, where the electrical characteristic is indicative of the power consumed by the display panel 10. In block S74, the power sensing circuitry 20 measures the amount of power consumed by the display panel 10 during the time period. The power sensing circuitry 20 outputs the amount of power to the display controller circuitry 30. Thereafter, the process advances to block S76.

In block S76, the display controller circuitry 30 may receive the output of the power sensing circuitry 20. As described above, the output of the power sensing circuitry 20 may include power consumption information for the display panel 10. From the power consumption information, the electronic processor 310 may extract the set of power values. Also in block S76, the electronic processor 310 performs the analysis of the set of power values by processing the set of power values. Specifically, in block S76, the electronic processor 310 obtains, as a set of power values based on measurements by the power sensing circuitry 20, the power consumed by the display panel 10 at points of time during the time period.

Also in block S76, the display controller circuitry 30 may determine, from the set of power values, the power parameter. The power parameter may include a statistical characteristic of the set of power values for the time period.

FIG. 7B is an example of a process performed by the electronic processor 310 during block S76. For example, the power parameter may include one or more of an average power of the set of power values, a standard deviation of the set of power values, and/or another statistical characteristic describing the fluctuation or variation of the set of power values over the time period. The memory 320 can include instructions for the electronic processor 310 to execute the process of FIG. 7B.

In block S762 of FIG. 7B, the electronic processor 310 determines whether or not a time period has expired. The process remains at block S762 until the electronic processor 310 determines that the time period has expired. Upon the expiration of the time period, the process in FIG. 7B proceeds to block S764.

In block S764, the electronic processor 310 may calculate a standard deviation (SD) of the power values. To calculate an average power (μ) of the set of power values, the electronic processor 310 may divide a sum of the set of power values by the amount of power values in the set of power values. Also in block S764, the electronic processor 310 may calculate the standard deviation (SD) using the formula:

$$SD = √ \frac{\sum {( {x}_{i} - μ )}^{2}}{N} ,$$

where xᵢ represents each power value from the set of power values and N is the amount or number of power values in the set of power values. When the electronic processor 310 calculates the standard deviation (SD), the process in FIG. 7B proceeds to block S766.

In block S766 of FIG. 7B, the electronic processor 310 may acquire a first one of the threshold values from the memory 320 to determine whether or not the standard deviation (SD) is less than the first one of the threshold values. The process in FIG. 7B proceeds from block S766 to block S767 when the electronic processor 310 determines that the standard deviation (SD) is less than the first one of the threshold values.

In block S767, the electronic processor 310 generates a mode command that includes information that associates the display mode in the predetermined display mode data with the amount of power that the display controller circuitry 30 ascertains by the analysis of the set of power values. The information in the mode command may include, as a new parameter, any of the display parameters for the display of the video content. The information in the mode command may also include the identifier for a new display mode. Thereafter, the process in FIG. 7B proceeds from block S767 to block S78 in FIG. 7A.

The process in FIG. 7B proceeds from block S766 to block S768 when the electronic processor 310 determines that the standard deviation (SD) is not less than the first one of the threshold values.

In block S768 of FIG. 7B, the electronic processor 310 may acquire a second one of the threshold values from the memory 320 and determine whether or not the standard deviation (SD) is greater than the second one of the threshold values. The second one of the threshold values has a value that is less than the first one of the threshold values. The process in FIG. 7B proceeds from block S768 to block S769 when the electronic processor 310 determines that the standard deviation (SD) is greater than the second one of the threshold values.

In block S769, the electronic processor 310 generates a mode command that includes information that associates the display mode in the predetermined display mode data with the amount of power that the display controller circuitry 30 ascertains by the analysis of the set of power values. The information in the mode command may include, as a new parameter, any of the display parameters for the display of the video content. The information in the mode command may also include the identifier for a new display mode. Thereafter, the process in FIG. 7B proceeds from block S769 to block S78 in FIG. 7A.

In block S78, the display panel 10 may automatically adjust the display mode of the display panel 10. Specifically, the display panel 10 extracts the mode command from the display mode information in block S78. The mode command controls the display panel 10 in a manner that causes the display panel 10 to the set the display parameters for the display mode of the display panel 10 to the display parameters that are in the mode command. For example, the display panel 10 may change the display mode from a first mode to a second mode. In changing the display mode, at least one of the display parameters (e.g., brightness, contrast, color temperature, and/or sharpness) of the display panel 10 is adjusted.

In some examples, the power parameter indicates a type of video content while also indicating the display mode to which the display panel 10 is changed for that type of video content. For example, when the power parameter is the standard deviation of the set of power values, and the standard deviation exceeds an upper threshold, the power parameter may reveal that the power consumed by the display panel 10 is fluctuating significantly enough to indicate that the video content on the display panel 10 is a streaming video (e.g., a movie) or a video game. In this scenario, the display controller circuitry 30 may output a mode command that indicates to the display panel 10 to enter a display mode configured for dynamic video content (a dynamic viewing mode), for example, a display mode for multimedia or movie viewing or a display mode for gaming as shown in FIG. 5. A dynamic viewing mode may be a display mode configured for viewing video content that changes significantly, and results in a power parameter that fluctuates significantly (e.g., above an upper threshold). In another example, when the power parameter is the standard deviation of the set of power values, and the standard deviation falls below a lower threshold, the power parameter may reveal that power is not fluctuating significantly, which may indicate that the video content on the display panel 10 is a generally static image or page of text for reading. In this scenario, the display controller circuitry 30 may output a mode command that indicates to the display panel 10 to enter a display mode for static video content (a static viewing mode), for example, a reading mode configured for a viewer to read text or a low blue light mode as shown in FIG. 5. In yet another example, when the power parameter is the standard deviation of the set of power values, and the standard deviation is between the upper and lower thresholds, the power parameter may indicate that power is fluctuating by an intermediate amount, which may indicate that the video content on the display panel 10 is a changing by a modest amount. In this scenario, the display controller circuitry 30 may output a mode command that indicates to the display panel 10 to enter a default or normal mode configured for modestly changing video content (e.g., during web browsing, use of office productivity software, or the like).

The process 70 may be repeated (e.g., continuously, periodically, or intermittently) such that the display panel 10 is repeatedly adjusted over time to match the type of video content being displayed on the display panel 10. For example, the process 70 may return to block S72 for the display panel 10 to display the video content during a next time period.

In block S74, the power sensing circuitry 20 measures the electrical characteristic indicative of power consumed by the display panel 10 when the display panel 10 displays video content during the next time period. In block S76, the display controller circuitry 30 may then obtain as a next set of power values based on measurements by the power sensing circuitry 20, the power consumed by the display panel 10 at points of time during the next time period. In block S76, the display controller circuitry 30 may determine the next power parameter of the next set of power values. In block S78, the display controller circuitry 30 may control, when the display controller circuitry 30 determines that the next power parameter reaches the threshold or another threshold, the display panel 10 to change to a further display mode having another different display setting for a display parameter of the display.

In examples in which the display controller circuitry 30 includes the video scaler IC, as described above, the video scaler IC may obtain the set of power values from the power sensing circuitry 20 (block S76), determine the power parameter (block S76), and determine that the power parameter reaches a threshold and control the display panel 10 to change to the different display mode (block S76).

In some examples in which the display controller circuitry 30 includes an EC and the additional processor, as described above, the EC obtains the set of power values from the power sensing circuitry 20 (block S76), determines the power parameter (block S76), and determines that the power parameter has reached one of the thresholds and control the display panel 10 to change to the display mode to a different display mode (block S78). To affect the control of the display panel 10 in block S78, the EC may transmit a mode command to the additional processor. The additional processor may, in turn, control the display panel 10 to change to the display mode indicated by the mode command.

In other examples in which the display controller circuitry 30 includes the EC and additional processor, as described above, the EC provides the set of power values from the power sensing circuitry 20 to the additional processor executing the OS. The OS may obtain the set of power values from the EC via an input-output (IO) access driver (block S78), determine the power parameter (block S76), and determine that the power parameter reaches a threshold and control the display panel 10 to change to the different display mode (block S78). To affect the control of the display panel 10 in block S78, the additional processor may generate control signals for controlling the display panel 10.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor, also referred to as an electronic processor, (e.g., a serial or parallel processor chip or specialized processor chip, a single- or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein. Accordingly, for example, examples of the technology can be implemented as a set of instructions, tangibly embodied on a non-transitory computer-readable media, such that a processor can implement the instructions based upon reading the instructions from the computer-readable media. Some examples of the technology can include (or utilize) a control device such as, e.g., an automation device, a special purpose or programmable computer including various computer hardware, software, firmware, and so on, consistent with the discussion herein. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular examples of the technology. Further, in some examples, certain operations can be executed in parallel or partially in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “only one of,” or “exactly one of.”

Although the present technology has been described by referring to certain examples, workers skilled in the art will recognize that changes can be made in form and detail without departing from the scope of the discussion.

What is claimed is:

1. A display apparatus comprising:
power sensing circuitry to measure, when a display panel displays content during a time period, an electrical characteristic indicative of power consumed by the display panel; and
display controller circuitry in communication with the power sensing circuitry, the display controller circuitry to:
obtain, as a set of power values based on measurements by the power sensing circuitry, the power consumed by the display panel at points of time during the time period,
determine a power parameter based on the set of power values, and
control, when the display controller circuitry determines that the power parameter reaches a threshold, the display panel to change to a different display mode.

2. The display apparatus of claim 1, wherein the threshold is an upper threshold, and the different display mode is a dynamic viewing mode.

3. The display apparatus of claim 1, wherein the threshold is a lower threshold, and the different display mode is a reading mode.

4. The display apparatus of claim 3, wherein the power parameter is a standard deviation of the set of power values.

5. The display apparatus of claim 1, wherein the power sensing circuitry includes:
a shunt resistor connected with a backlight circuit of the display; and
a current sensor to sense current through shunt resistor.

6. The display apparatus of claim 1, wherein, to control the display panel to change to the different display mode, the display controller circuitry is to control the display panel to one or more of:
adjust a sharpness of the display panel,
adjust a brightness peaking of the display panel,
adjust a response time of the display panel, or a color temperature of the display panel.

7. The display apparatus of claim 1, wherein the power sensing circuitry and the display controller circuitry are housed by a housing of a standalone electronic display and the display controller circuitry is a scaler integrated circuit (IC).

8. The display apparatus of claim 1,
wherein the power sensing circuitry and the display controller circuitry are integrated into a laptop, and the display controller circuitry includes an embedded controller (EC) of the laptop, and
wherein, to control the display panel to change to the different display mode, the EC is to output a mode control command to an additional processing unit of the laptop, the mode control command indicating a request to the additional processing unit to change the display panel to the different display mode.

9. The display apparatus of claim 1,
wherein the power sensing circuitry and the display controller circuitry are integrated into a laptop, and the display controller circuitry includes a processing unit executing an operating system,
wherein, to obtain the power consumed by the display panel at points of time during the time period, the processing unit is to receive the set of power values via an input/output (I/O) access driver from one selected from the group consisting of an embedded controller (EC) of the laptop and a memory of the laptop.

10. A method for adjusting a display panel, the method comprising:
measuring, by power sensing circuitry when a display panel displays content during a time period, an electrical characteristic indicative of power consumed by the display panel; and
obtaining, by display controller circuitry, as a set of power values based on measurements by the power sensing circuitry, the power consumed by the display panel at points of time during the time period;
determining, by the display controller circuitry, a power parameter of the set of power values; and
controlling, by the display controller circuitry when the display controller circuitry determines that the power parameter reaches a threshold, the display panel to change to a different display mode having a different setting for at least one display parameter of the display.

11. The method of claim 10, wherein, to control the display panel to change to the different display mode, the controller is to control the display panel to one or more of:
adjust a sharpness of the display panel,
adjust a brightness peaking of the display panel, and
adjust a response time of the display panel, or a color temperature of the display panel.

12. The method of claim 10, wherein the controller is to:
control, when the controller determines that the standard deviation is above an upper threshold, the display panel to change to a dynamic viewing mode.

13. The method of claim 10, wherein the threshold is a lower threshold, and the different display mode is a reading mode.

14. The method of claim 10, wherein the threshold is an upper threshold, and the different display mode is a dynamic viewing mode.

15. An electronic device comprising:
a display panel;
power sensing circuitry to measure, when the display panel displays content during a time period, an electrical characteristic indicative of power consumed by the display panel; and
a display controller circuitry in communication with the power sensing circuitry, the display controller circuitry to:
obtain, as a set of power values based on measurements by the power sensing circuitry, the power consumed by the display panel at points of time during the time period,
determine a power parameter of the set of power values, and
control, when the display controller circuitry determines that the power parameter reaches a threshold, the display panel to change to a different display mode.
